(19) United States
(12) Patent Application Publication
(10) Pub. No.: US 2024/0240696 A1
(43) Pub. Date: Jul. 18, 2024

(54) CONNECTOR FOR COMMERCIAL PLAYGROUND EQUIPMENT

(71) Applicant: Landscape Structures Inc., Delano, MN (US)

(72) Inventors: Darryl T. WROLSON, Minnetrista, MN (US); Daniel OSTERBERG, Brooklyn Park, MN (US); Tory ROFF, Marshall, NC (US)

(21) Appl. No.: 18/412,790

(22) Filed: Jan. 15, 2024

Related U.S. Application Data
(60) Provisional application No. 63/480,054, filed on Jan. 16, 2023.

(51) Int. Cl. F16G 11/12

(52) U.S. Cl. CPC F16G 11/12

(57) ABSTRACT

Embodiments of a connector for commercial playground equipment are disclosed. In one embodiment, a playground component is provided that includes a connector pre-loaded on a rope. The connector includes a connector nut, optionally a washer, and a connector base that are kept from sliding off the end of the rope by a stop. The stop in one embodiment is a ferrule attached to the end of the rope. A specially shaped opening is formed in another component that is also part of the playground component. The specially shaped opening is configured such that at least a portion of the connector base is insertable through the opening when the connector base is rotated to a first orientation, but the connector base is unable to be pulled back through the specially shaped opening when rotated to a second orientation after insertion into the other component.

### CROSS-REFERENCE TO RELATED APPLICATION

The present application is based on and claims the benefit of U.S. provisional patent application Ser. No. 63/480,054, filed Jan. 16, 2023, the content of which is hereby incorporated by reference in its entirety.

### BACKGROUND

The present invention relates generally to the field of commercial playground equipment, and more particularly to a connector for use in constructing commercial playground equipment.

In the construction of commercial playground equipment, it is often necessary to attach ropes to other components such as but not limited to tubes. The design of traditional rope attachment schemes usually involves the use of loose hardware in one form or another. Loose hardware is cumbersome in that it has tendency to get lost, misplaced, or even accidentally left out when the commercial playground equipment is shipped out. Traditional design schemes also often suffer from a vulnerability to corrosion and sometimes a need for welding and welding cleanup.

Another drawback of many traditional rope attachment schemes is a substantially limited range of motion in terms of how the rope is able to move in relation to the other component at the point of attachment. For example, a bolt or similar mechanism is in many cases utilized to secure a connector placed on the end of the rope to a tab that is welded onto the other component. This approach often supports only an up-and-down motion of the rope relative to the other component. It is possible to utilize a more sophisticated connector on the end of the rope, for example a connector with an integrated swivel. More sophisticated connectors though often add only some additional motion such as a limited side-to-side motion to supplement an already limited up-and-down motion. In some cases, additional hardware such as spacers becomes necessary. In view of at least the above noted issues, there is a need for a rope connection scheme that is easy to install and adjust, resistant to corrosion, requires minimal hardware, and/or allows for a generous range of motion of the rope.

### SUMMARY

Embodiments of a connector for commercial playground equipment are disclosed. In one embodiment, a playground component is provided that includes a connector pre-loaded on a rope. The connector includes a connector nut, optionally a washer, and a connector base that are kept from sliding off the end of the rope by a stop. The stop in one embodiment is a ferrule attached to the end of the rope. A specially shaped opening is formed in another component also part of the playground equipment. The specially shaped opening is configured such that at least a portion of the connector base is insertable through the opening when the connector base is rotated to a first orientation, but the connector base is unable to be pulled back through the specially shaped opening when rotated to a second orientation after insertion into the other component.

### BRIEF DESCRIPTION OF THE DRAWINGS

FIG. 1 is a schematic illustration of three different examples of existing connection approaches.

FIG. 2 is a flow chart diagram demonstrating a method of connecting a rope to a tube.

FIG. 3 is a schematic profile view of a rope with a pre-loaded connector.

FIG. 4 is schematic representation of a tube having a specially shaped opening formed therein.

FIG. 5 is schematic representation of the connector base portion of the pre-loaded connector being inserted into the specially shaped opening formed in the tube.

FIG. 6 is schematic representation of the connector base being reoriented following insertion into the tube.

FIG. 7 is schematic representation of an optional washer being slid into its place.

FIG. 8 is a schematic representation of a plurality of optional enhancements.

FIG. 9 is a schematic representation of a connector nut after having been secured to the connector base.

FIG. 10 is a schematic representation of a spanner wrench engaged with one or more tightening openings.

### DETAILED DESCRIPTION

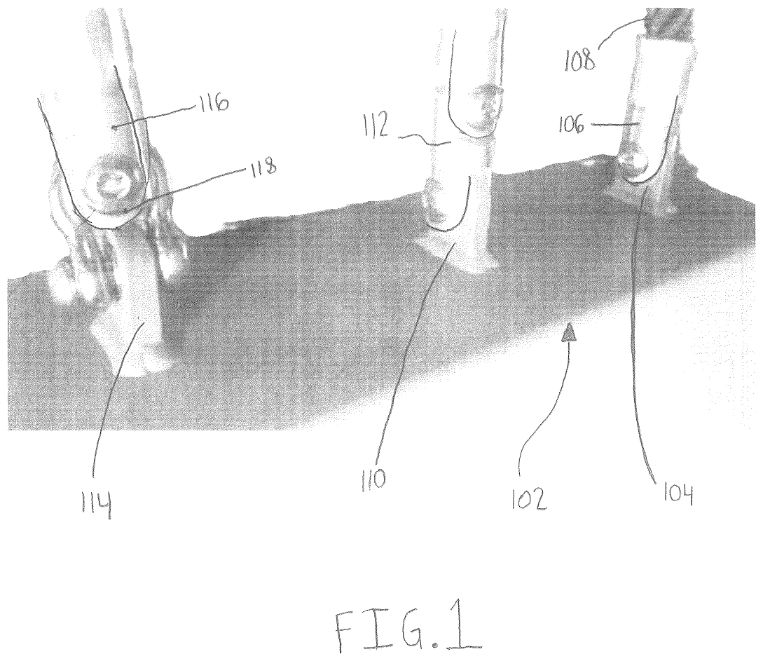

FIG. 1 is a schematic illustration of three different examples of existing approaches to connecting a rope to another component in the context of a commercial playground installation. In a first example approach, a tab 104 has been welded onto another component 102. A connector 106 is attached (e.g., swaged onto) the end of a rope 108. The connector 106 is fastened to the tab 104 (i.e., bolted through openings formed in the tab 104 and the connector 106) such that the rope 108 is essentially able to move, if at all, in an up-and-down direction relative to component 102.

In a second example approach, a tab 110 has been welded onto the other component 102. A connector 112 is attached (e.g., swaged onto) the end of a rope (this rope is omitted in FIG. 1). The connector 112 is fastened to the tab 110 (i.e., bolted through openings formed in the tab 110 and the fastener 112) such that the rope is essentially able to move, if at all, in an up-and-down and/or side-to-side direction relative to component 102. Connector 112 is different than connector 106 in that it also includes a swivel that adds the additional possibility of side-to-side motion.

In a third example approach, a tab 114 has been welded onto the other component 102. A connector 116 is attached (e.g., swaged onto) the end of a rope (this rope is omitted in FIG. 1). The connector is fastened to the tab 114 utilizing a bolt link 118. The bolt link 118 is ultimately bolted to both the connector 116 and the tab 114. The end result is that the rope is able to move, if at all, in generally up-and-down and side-to-side directions.

The example approaches to attaching a rope to component 102 shown in FIG. 1 result in substantially limited rope motion relative to component 102. All three approaches require welding and usually welding clean-up. Even if welding is avoided, for example, by providing a different type of connection point, the limited range of motion is still typically an issue. Further, all of the example approaches shown in FIG. 1 require cumbersome loose hardware such as bolts, spacers and bushings. Further, the shown example approaches are vulnerable to corrosion and rapid wear/tear.

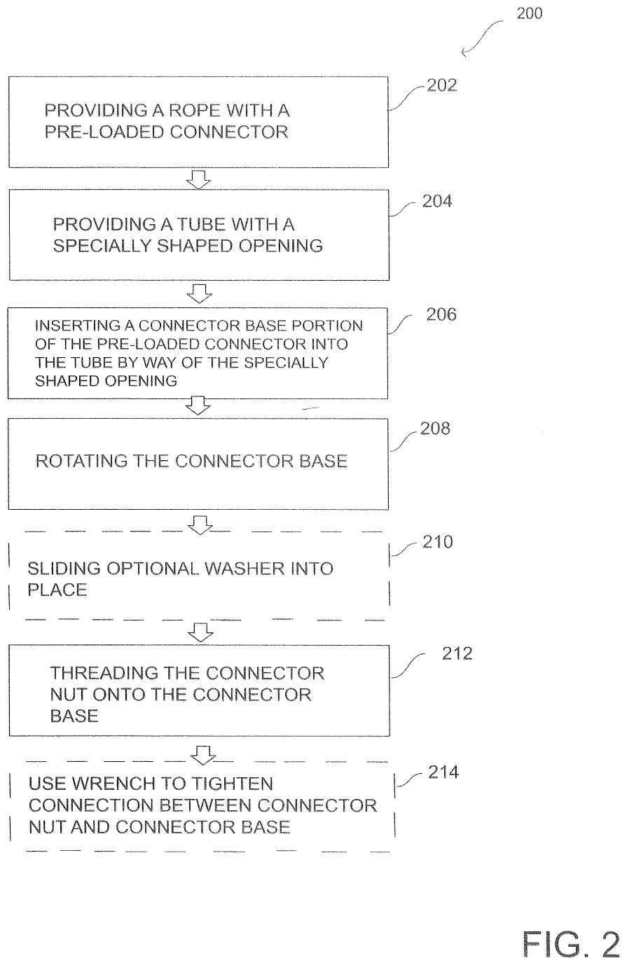

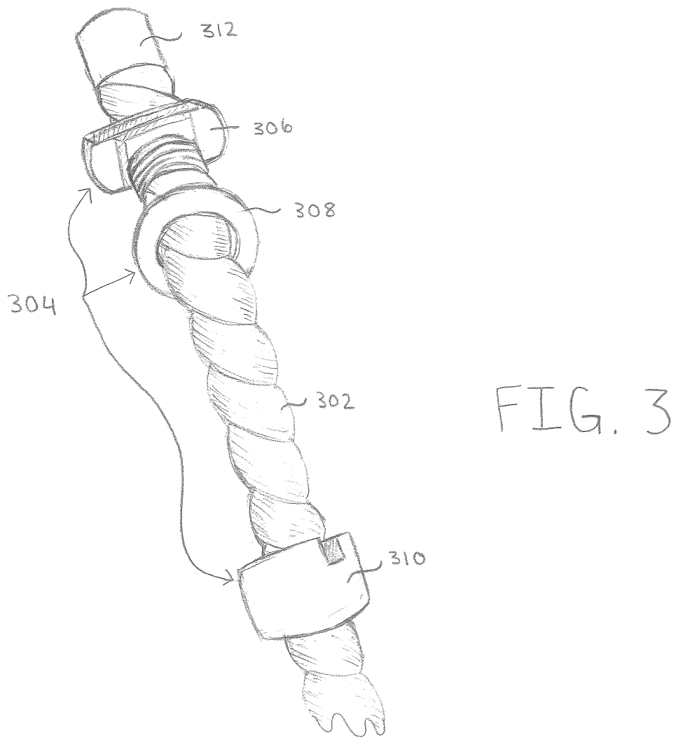

FIG. 2 is a flow chart diagram demonstrating an alternative method 200 of connecting a rope to another component. In accordance with block 202, the method begins with providing a rope with a pre-loaded connector. Consistent with this step, FIG. 3 is a schematic profile view of a rope 302 with a connector 304 pre-loaded thereon. Connector 304 is comprised of a connector base 306, an optional washer 308 and a connector nut 310. All three of components 306, 308 and 310 are illustratively slidably received on the rope 302. The components of connector 304 are prevented from sliding off of the end of rope 302 by a stop 312, which is illustratively though not necessarily a ferrule. In one embodiment, some or all of the connector base 306, the optional washer 308 and the connector nut 310 are die-cast components.

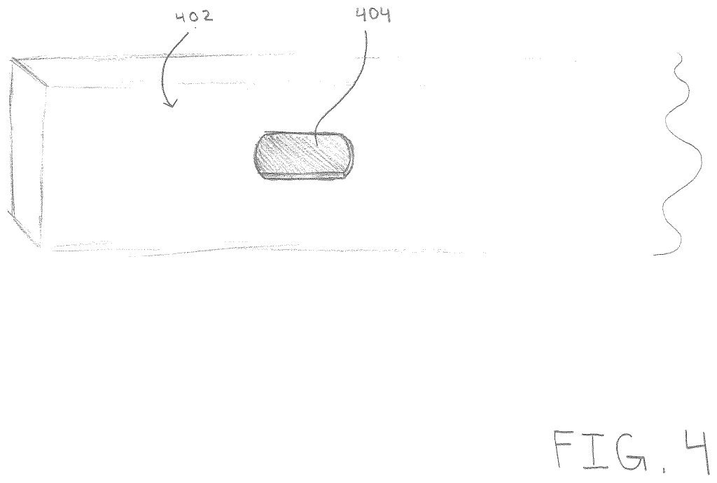

Next, in accordance with block 204, another component (illustratively though not necessarily a square or round tube) is provided with a specially shaped opening. Consistent with this step, FIG. 4 is schematic representation of a component 402 having a specially shaped opening 404 formed therein. In one embodiment, opening 404 is formed by laser cutting. In one embodiment, the overall shape and size of the opening 404 are such that the connector base 306 shown in FIG. 3 can be inserted through the opening 404 into the component 402 when oriented in a horizontal way. However, once the connector base 306 has been inserted through the opening 404, it is illustratively rotated, for example, by 90 degrees, to a vertical orientation. In the vertical orientation, it illustratively cannot be pulled out of opening 404, nor could it have been inserted through opening 404 in the vertical orientation.

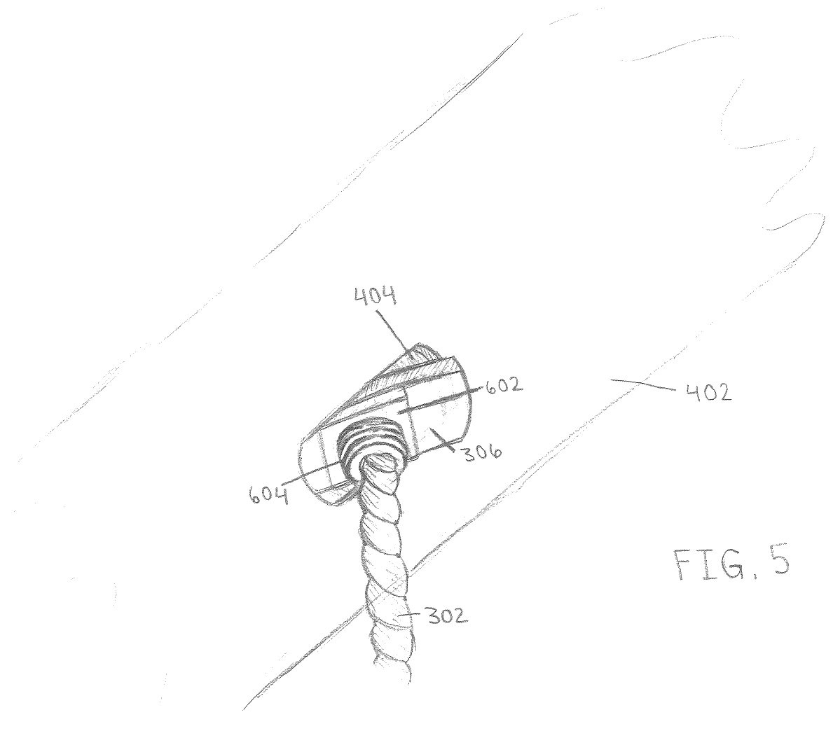

Accordingly, and consistent with block 206, the connector base 306 is therefore inserted through the specially shaped opening 404 in component 402 (again, illustratively though not necessarily a square or round tube). FIG. 5 is schematic representation of the connector base 306 being inserted. Of course, when this insertion is made, the connector base 306 is oriented in a position that makes such an insertion possible.

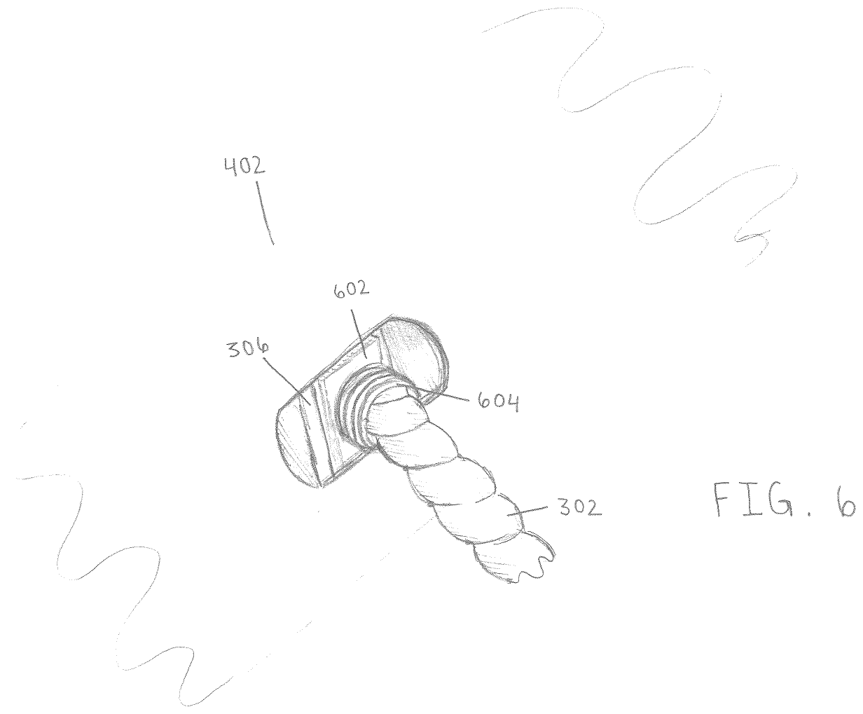

Next, consistent with block 208, the connector base 306 is rotated into an orientation that makes withdrawal of the connector base through the specially shaped opening 404 in component 402 (again, illustratively though not necessarily a square or round tube) essentially impossible. FIG. 6 is schematic representation of the connector base 306 being reoriented following insertion. In one embodiment, one or more raised edges 602 (labeled in FIGS. 5 and 6) are formed in the connector base 308 to serve as an indicator as to how the connector base 306 should be oriented after being rotated. The raised edges are also illustratively configured to resist movement of the connector base 306 within specially shaped opening 404 after the connector base 306 is reoriented following insertion. As is also shown in FIGS. 5 and 6, a threaded portion 604 is left protruding from specially shaped opening 404 after connector base 306 is reoriented following insertion. In this regard, the connector base 306 is actually only partially inserted into specially shaped opening 404 instead of being completely inserted.

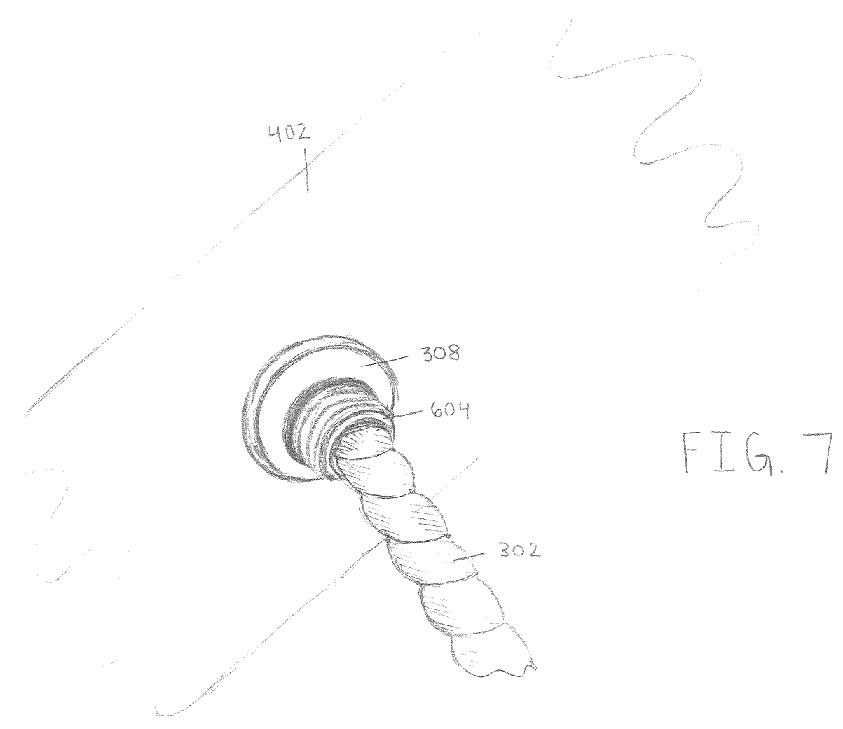

In an optional next step, an optional washer 308 is slid over threads 604 and positioned so as to be flush with component 402. FIG. 7 is schematic representation of the optional washer 308 being slid into its place. In one embodiment, the optional washer 308 therefore conceals the specially shaped opening 404 in component 402.

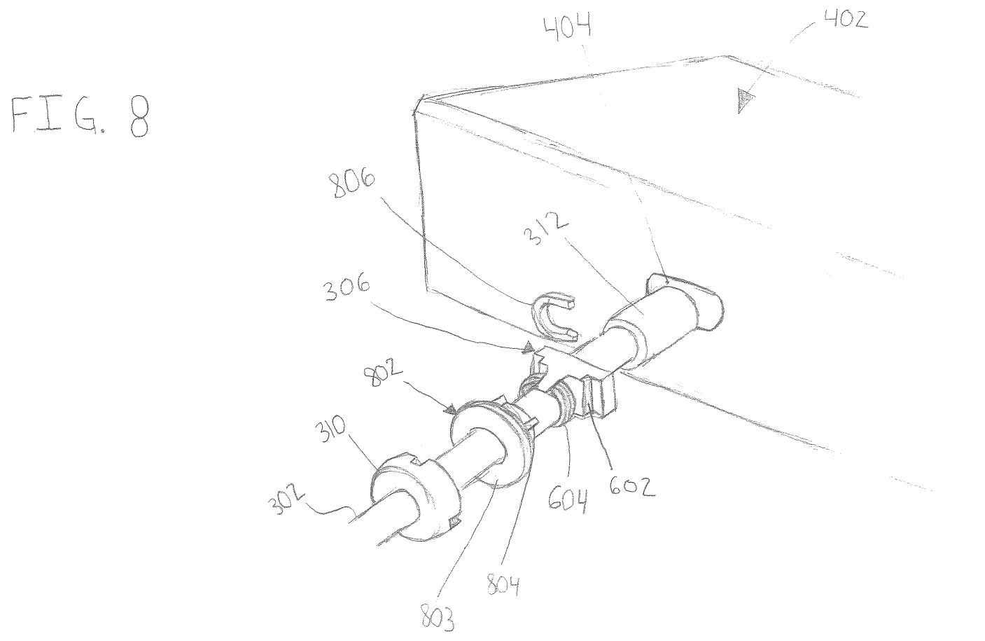

Washer 308 is but one example of optional components that can be included or excluded in the described configuration. FIG. 8 is a schematic representation of some optional enhancements. Another example of an optional component that can also or alternatively be included is a locking mechanism. Locking mechanism 802 has an outer flange that is configured to operate in a manner similar to optional washer 308. However, locking mechanism 802 also includes one or more locking extensions 804. Locking extension 804 is illustratively configured to extend into specially shaped opening 404 and over a portion of the connector base 306. In this manner, locking mechanism further secures the connector base 306 within the tube. In essence, locking mechanism 802 provides further mechanical assurance that the connector base will not slide back out of specially shaped opening 404. The locking extension 804 essentially prevents locking mechanism 802 from rotating within the specially shaped opening 404, which in turn also prevents connector base 306 from rotating. In this manner, it is even possible for the reorientation of connector base 306 after insertion to be made an optional step in the process, though it is possibly preferable to still orient connector base in an orientation that discourages withdrawal from the specially shaped opening 404. In one embodiment, locking mechanism 802 is a replacement for optional washer 308.

Another optional enhancement is a spacer 806. Spacer 806 is shown as being added on between stop (e.g., ferrule) 312 and connector base 306. In one embodiment, the spacer 806, which could just as easily be multiple spacers 806, is configured to push stop 312 (and therefore the end of rope 302) further into the component to which attachment is being made. This ultimately increases the amount of tension on rope 302. In one embodiment, spacers 806 can be added at initial installation but also can just as easily be added long after initial installation, for example, after rope 302 has stretched out following extensive use. Those skilled in the art will also appreciate that the spacer 806 need not be simply a static space filler. The spacer 806 can just as easily be a spring configured to provide variable tension to rope 302. Any kind of spacer is possible. The general idea is to increase the amount of tension (variably or statically) by shortening the amount of rope that extends out through the connector base 306.

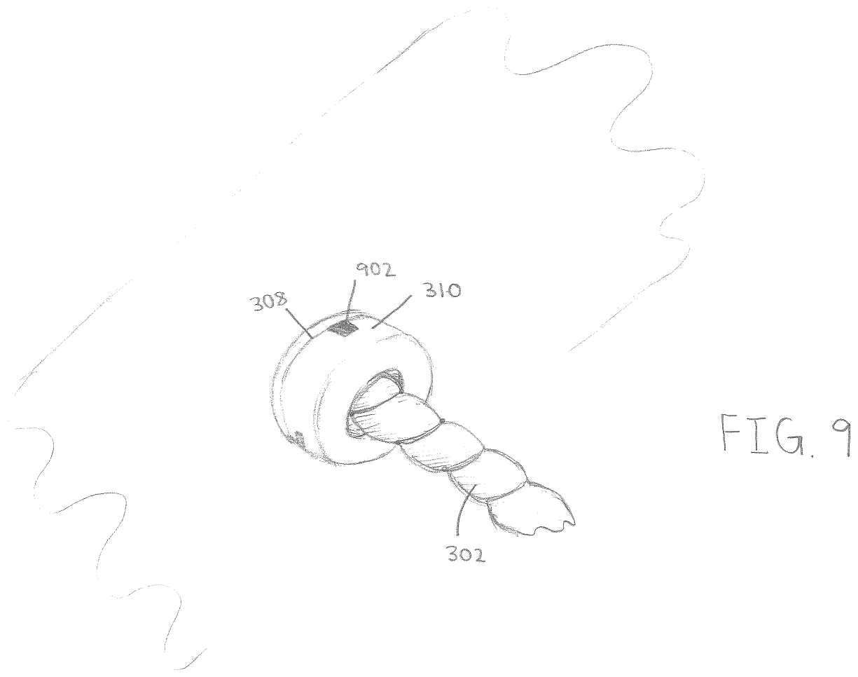

A final step, in accordance with block 212 in FIG. 2, is to secure the connector nut 310 to the threads 604 of the connector base 306. FIG. 9 is a schematic representation of the connector nut after having been secured to the connector base. In one embodiment, this means the connector nut is outfitted with threads designed to engage with threads 604. Of course, the scope of the present invention is not limited to connection by threads. Other connection approaches can be substituted without departing from the scope, as those skilled in the art will appreciate.

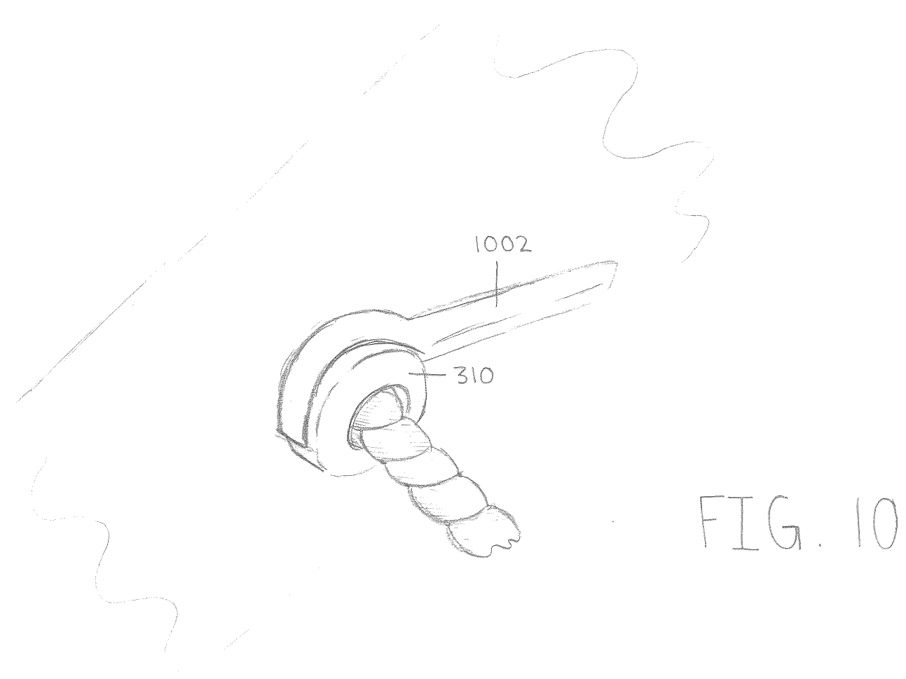

In FIG. 9, the presence of an optional washer 308 is also apparent. Of course, this could alternatively be a portion of a locking mechanism 802. Another subtle feature shown in FIG. 9 are one or more tightening openings 902. These openings are illustratively incorporated into the connector nut 301 in order to facilitate engagement with a wrench 1002 (e.g., a spanner wrench) or achieving more than hand-tightened security. FIG. 10 is a schematic representation of a spanner wrench engaged with one or more tightening openings 902.

Certain embodiments disclosed here support a rope connection scheme that is easy to install and adjust, requires minimal hardware, and allows for a broad range of motion. The connection scheme can be utilized to connect a rope to a tube, as is reflected in some of the Figures but only as one example. The same or similar scheme could be utilized to connect a rope to most anything. For example, the scheme could be utilized to connect to a face of a deck, in which case there would not be containment of components such as within a tube. Those skilled in the art will appreciate the broad applicability of embodiments of the described attachment schemes, as well as obvious extensions thereof.

In one scenario, a connector comprising a die cast connector base, washer, and connector nut come pre-loaded on a rope when shipped (held on by a ferrule or other stop on the end of the rope). A corresponding component includes a laser-cut specially shaped opening that enables the connector base to be inserted through the opening in one orientation and prevented from extraction from the opening when rotated to an alternate orientation. The connector nut is engaged to a threaded portion of the connector based that protrudes from the specially shaped opening. This approach requires no welds, and the look and feel of the resulting connection is clean.

Certain embodiments disclosed herein allow for a broad, nearly 360-degree rotation of the rope after connection. Certain embodiments are easy to install and to adjust rope tension adding a static and/or variable spacer. Certain embodiments are more cost-effective than traditional hardware-based connection systems, which are typically mostly metal. By eliminating a connection tab, there is no longer a risk of a component being shipped without a tab, and the risk of hardware for connection not being shipped is also eliminated. Certain embodiments described herein also reduces or eliminates corrosion risk.

Although the above-discussed features of certain embodiments of the present invention provide significant advantages over prior art rope connectors, it should be noted that other approaches to solving the problems associated with traditional rope connectors may exist. However, these alternative approaches may not provide the same level of simplicity, ease of installation and adjustment, range of motion, and cost-effectiveness as certain embodiments of the present invention.

Certain embodiments disclosed herein are applicable to essentially any type of playground components and ropes. The precise nature of the playground component or rope will often vary from one installation to the next. The shape of the playground component to which attachment is being made, be it square, round, a tube, not a tube, the face of a deck, or otherwise, is not important to the scope of the present invention. Further, the playground component may be made of metal, plastic, or composite materials, or otherwise, and the rope may be made of natural or synthetic fibers, metal, a blend, or otherwise depending on the desired characteristics and performance of a given playground component. These details are not critical to the scope of the present invention.

Further, certain embodiments described herein may be utilized in a variety of playground components including but certainly not limited to swings, climbing structures, and rope bridges. These are only examples. The embodiments provide a versatile and adaptable solution for connecting ropes in various playground applications. And really, embodiments could just as easily be applied to connect items other than ropes to items other than tubes, without departing from the scope of the present invention.

Although this description has presented with reference to particular embodiments, workers skilled in the art will recognize that changes may be made in form and detail without departing from the spirit and scope of the invention.

What is claimed is:

1. A playground component, comprising:
a rope having a connector pre-loaded thereon, the connector including a connector base and a connector nut;
a component having a specially shaped opening formed therein;
wherein the specially shaped opening is configured such that at least a portion of the connector base is insertable through the specially shaped opening when the at least a portion of the connector based is rotated to a first orientation; and
wherein the specially shaped opening is configured such that the at least a portion of the connector base cannot be pulled back through the specially shaped opening when the at least a portion of the connector base is rotated to a second orientation after the at least a portion of the connector base has been inserted into the component through the specially shaped opening.

2. The playground component of claim 1, further comprising a stop connected to an end of the rope so as to prevent the connector base and the connector nut from sliding off of the end of the rope.

3. The playground component of claim 1, further comprising a washer positioned on the rope between the connector base and the connector nut.

4. The playground component of claim 3, wherein the connector base, the connector nut, and the washer are all slidably secured to the rope with the stop preventing the connector base, the connector nut and the washer from sliding off the end of the rope.

5. The playground component of claim 1, wherein the connector base and the connector nut are die-cast components.

6. The playground component of claim 1, wherein the connector nut is configured to be attached to the connector base such that a portion of the component that defines the specially shaped opening is sandwiched between the connector nut and the at least a portion of the connector base.

7. The playground component of claim 6, further comprising a washer that also gets sandwiched between the connector nut and the at least a portion of the connector base when the connector nut is attached to the connector base such that the portion of the component that defines the specially shaped opening is sandwiched between the connector nut and the at least a portion of the connector base.

8. The playground component of claim 6, further comprising one or more spacers that are configured to increase how far the stop extends into the component when the connector nut is attached to the at least a portion of the connector base such that the portion of the component that defines the specially shaped opening is sandwiched between the connector nut and the at least a portion of the connector base.

9. The playground component of claim 8, wherein the spacer is a spring.

10. The playground component of claim 1, wherein the connector nut is configured to be attached to a portion of the connector base that extends out of the specially shaped opening after the at least a portion of the connector base has been inserted into the component through the specially shaped opening and rotated to the second orientation.

11. A method of assembling a playground component, the method comprising:
providing a rope having a connector pre-loaded thereon, the connector including a connector base and a connector nut;
providing a component having a specially shaped opening;
placing at least a portion of the connector base into a first orientation and then inserting the at least a portion into the component through the specially shaped opening;
rotating the at least a portion of the connector base to a second orientation within the component such that the at least a portion of the connector base cannot be pulled back through the specially shaped opening when the at least a portion of the connector base is in the second orientation; and
securing the connector nut to a portion of the connector base, thereby securing the rope to the component.

12. The method of claim 11, wherein securing the connector nut to the portion of the connector further comprises securing the connector nut to a portion of the connector base that protrudes through the specially shaped opening to an area outside of the component.

13. The method of claim 11, further comprising adjusting tension on the rope by positioning one or more spacers on the rope inside the component.

14. The method of claim 11, wherein securing the connector nut to the portion of the connector further comprises threading the connector nut to the portion of the connector.

15. The method of claim 11, wherein providing a rope having a connector further comprises providing a rope having a connector that includes a die-cast connector base and a die-cast connector nut.

16. The method of claim 11, wherein providing a rope having a connector pre-loaded thereon further comprises providing a rope having a connector that is prevented by a stop from sliding off of an and of the rope.

17. A playground component, comprising a component and a rope connected to the component utilizing a connector that is preloaded onto the rope utilizing a stop that prevents components of the connector from sliding off of the end of the rope.

18. The playground component of claim 17, wherein the connector includes a connection base with a portion that can be inserted through a specially shaped opening in the component when the portion is rotated to a first orientation but not when the portion is rotated to a second orientation.

19. The playground component of claim 18, wherein the connector base further comprises a connection nut that is configured to be threaded to the connection base.

20. The playground component of claim 19, wherein the connection base and the connection nut are die-cast.
